(19) United States
(12) Patent Application Publication
(10) Pub. No.: US 2013/0280489 A1
(43) Pub. Date: Oct. 24, 2013

(54) LAMINATED STRUCTURE AND MANUFACTURING METHOD OF PROCESSED PRODUCT

(71) Applicants: Yusuke Nakai, Hiroshima (JP); Tadashi Nakamura, Tokyo (JP); Shinji Makino, Hiroshima (JP)

(72) Inventors: Yusuke Nakai, Hiroshima (JP); Tadashi Nakamura, Tokyo (JP); Shinji Makino, Hiroshima (JP)

(73) Assignee: Mitusubishi Rayon Co., Ltd., Toyko (JP)

(21) Appl. No.: 13/997,463

(22) PCT Filed: Dec. 27, 2011
(86) PCT No.: PCT/JP2011/080210

§ 371 Date: Jun. 24, 2013

(30) Foreign Application Priority Data
Dec. 27, 2010 (JP) 2010290959

(51) Int. Cl. B32B 38/18; B32B 3/30

(52) U.S. Cl. CPC B32B 38/1866; B32B 3/30
USPC 428/142; 156/221

(57) ABSTRACT

The present invention relates to a laminated structure having a molded body that has a fine concavo-convex structure on a surface thereof and a protection film that is allowed to come into contact with the surface of the molded body on the side of the fine concavo-convex structure, in which the average interval between convexes of the fine concavo-convex structure is equal to or shorter than a wavelength of visible light, and adhesion strength of the protection film when the protection film is attached to the fine concavo-convex structure is 0.1 to 1.7 N/25 mm. According to the present invention, a laminated structure for manufacturing a processed product which can be easily processed without causing the protection film to be easily detached and has little residual adhesive can be provided.

### TECHNICAL FIELD

The present invention relates to a laminated structure having a fine concavo-convex structure on a surface thereof and a manufacturing method of a processed product.

Priority is claimed on Japanese Patent Application No. 2010-290959, filed Dec. 27, 2010, the content of which is incorporated herein by reference.

### BACKGROUND ART

Various displays, lenses, show windows, and the like have a problem in that visibility of interfaces (surfaces) thereof in contact with air is lowered due to reflection of sun light, illumination, or the like on the surfaces.

In order to reduce reflection, for example, there is a method for attaching an anti-reflection film to a surface of an object.

Thus, such an anti-reflection film is required to have low reflectance and low dependency of reflectance on wavelengths.

As an anti-reflection film, a film, which has a structure in which a number of films having different refractive indexes are laminated so that reflection light on the surface of the film and reflection light on the interface between the film and an object are negated by interference, has been known. Generally, reflectance and dependency of reflectance on wavelengths tend to be lowered if the number of laminated films increases.

Such a film is generally manufactured using sputtering, vapor deposition, coating, or the like. However, such methods have a limit on lowering reflectance and dependency of reflectance on wavelengths even if the number of laminated films increases. In addition, in order to reduce the number of laminated films for the purpose of slashing manufacturing cost, a material having a far lower refractive index has been required.

To lower a refractive index of a material, introducing air to the material using various methods is effective, and among these, for example, a method in which a fine concavo-convex structure is formed on a surface of a film has been known. Particularly, a fine concavo-convex structure called a moth-eye structure is effective anti-reflection means by continuously increasing a refractive index of air to a refractive index of a material.

As a method for forming a fine concavo-convex structure on a surface of a material, there are a method for directly processing a surface of a material, a transfer method for transferring a fine concavo-con vex structure using a mold having a reverse structure corresponding thereto, and the like, and the latter method is better in terms of productivity and economic feasibility. As a method for forming a reverse structure in a mold, electron beam lithography, laser interferometry, and the like are known, and in recent years, there has been a focus on alumina having a fine concavo-convex structure formed using anodization as a mold that can be manufactured in a simple manner (for example, refer to Patent Literature 1). Patent Literature 1 discloses an anti-reflective film manufactured using, as a mold, anodized porous alumina having a surface on which a fine concavo-convex structure with pores having periodic intervals of 50 to 300 nm is formed.

Generally, to a molded body such as a film, or the like having a surface on which a fine concavo-convex structure is formed, a protection film is attached to the surface on which the fine concavo-convex structure is formed for the time from processing or shipping to use of the item, for the purpose of preventing adhesion of contaminants onto the surface or maintaining (protecting) the shape of the fine concavo-convex structure.

However, as described in Patent Literature 1, in the molded body formed with the fine concavo-convex structure of the moth-eye structure on a surface of the anodized porous alumina by transferring the fine concavo-convex structure of a cycle equal to or shorter than the wavelength of visible light onto the surface, the intervals between convexes are narrower than those in general fine concavo-convex structures, and the area in which a protection film is attached to tips of convexes is small. For this reason, it is difficult to attach a protection film, which is generally used for an anti-glare (AG) structure or a prism structure having a cycle of an concavo-convex structure longer than the wavelength of visible light, onto the surface of the fine concavo-con vex structure of the moth-eye structure. In other words, with a general protection film, sufficient adhesion strength may not be obtained, or conversely, adhesion strength becomes easily excessive.

Thus, in order to make a protection film be easily attached, to prevent the attached protection film from being easily detached, and to make the protection film be easily detached when it is intended, a method for attaching the protection film having initial adhesion strength with respect to an uneven portion of 0.03 N/25 mm or lower onto a surface of a molded body on which uneven portions with a fine concavo-convex structure and even portions without the fine concavo-convex structure are formed has been proposed (Refer to Patent Literature 2).

### CITATION LIST

### Patent Literature

[Patent Literature 1] Japanese Unexamined Patent Application, First Publication No. 2005-156695
[Patent Literature 2] Japanese Unexamined Patent Application, First Publication No. 2010-107858

### SUMMARY OF INVENTION

### Technical Problem

However, processing the molded body with a protection film (laminated structure) disclosed in Patent Literature 2 in a desired shape using NC cutting, or the like is not considered. For this reason, it was found that, if such a molded body with a protection film (laminated structure) is processed in NC cutting, or the like, problems that the protection film is detached during processing, the position of the molded body deviates during processing, or damage to a surface of the molded body is made arise.

In addition, when a molded body having a fine concavo-convex structure on both of its surfaces, or a molded body having the fine concavo-convex structure on an entire surface thereof is processed, it is obvious that the molded body is particularly vulnerable to the problems described above.

In order not to allow a protection film to be detached during processing, a protection film having strong adhesiveness may be used, but in this case, it is obvious that a phenomenon in which an adhesive of the protection film remains in concave portions of the fine concavo-convex structure of a molded body (residual adhesive) occurs after the protection film is detached. When the residual adhesive is found in the concave portions, optical performance of the molded body easily deteriorates.

Particularly, when a protection film is attached onto a surface of the fine concavo-convex structure of the moth-eye structure, an adhesive easily remains in concave portions thereof after the protection film is detached.

The present invention takes the above-described circumstances into consideration, and provides a laminated structure that includes a molded body with a fine concavo-convex structure on a surface thereof and a protection film that comes into contact with the surface, and a manufacturing method of a processed product that can be easily processed without causing each detachment of the protection film, and has little residual adhesive when the laminated structure is processed.

### Solution to Problem

As a result of extensive review conducted by the present inventors, detachment of a protection film during processing of a laminated structure can be suppressed by using the protection film having specific adhesion strength and performing a cleaning step after a processing step, and as a result, the inventors have completed the present invention by finding a method that can protect a fine concavo-convex structure even during the processing, and can easily manufacture a processed product in a complicated shape without scratches and adhesion of contaminants while suppressing a residual adhesive.

In other words, a first aspect of the present invention relates to a laminated structure having a molded body that has a fine concavo-convex structure on a surface thereof and a protection film that is allowed to come into contact with the surface of the molded body on the side of the fine concavo-convex structure, in which the average interval between convexes of the fine concavo-convex structure is equal to or shorter than a wavelength of visible light, and adhesion strength of the protection film when the protection film is attached to the fine concavo-convex structure is 0.1 to 1.7 N/25 mm.

A second aspect of the present invention relates to a manufacturing method of a processed product for processing the laminated structure of the first aspect to be a processed product in a predetermined shape, the method including an attachment step of attaching a protection film onto a surface having a fine concavo-convex structure of the molded body to protect the surface, and a processing step of processing the protection film and the molded body to be in a predetermined shape.

After the processing step, it is preferable to include a cleaning step of detaching the protection film from the laminated structure, and then cleaning the molded body.

The cleaning step is preferably a wet cleaning step using a cleaning solution.

### Advantageous Effects of Invention

According to the laminated structure of the present invention, the laminated structure that has a protection film easily processed without being mistakenly detached, and enables manufacturing of a processed product with little residual adhesive can be provided.

According to the manufacturing method of a processed product of the present invention, a processed product that enables easy processing without a protection film being easily detached and has little residual adhesive can be manufactured when a laminated structure having a fine concavo-convex structure on its surface onto which the protection film is attached is processed.

### BRIEF DESCRIPTION OF DRAWINGS

FIG. 1 is a vertically cross-sectional diagram showing an example of a molded body with double-side protection films (laminated structure), which is used in the present invention, obtained by attaching the protection films to both surfaces of the molded body having a fine concavo-convex structure thereon.

FIG. 2 is a vertically cross-sectional diagram showing an example of a molded body used in the molded body with double-side protection films (laminated structure) shown in FIG. 1.

FIG. 3 is a configuration diagram showing an example of a manufacturing device of a molded body with a single-side protection film (laminated structure) constituting the molded body with double-side protection film (laminated structure) shown in FIG. 1.

FIG. 4 is a cross-sectional diagram showing manufacturing steps of a mold having anodized alumina on its surface.

### DESCRIPTION OF EMBODIMENTS

Hereinafter, the present invention will be described in detail.

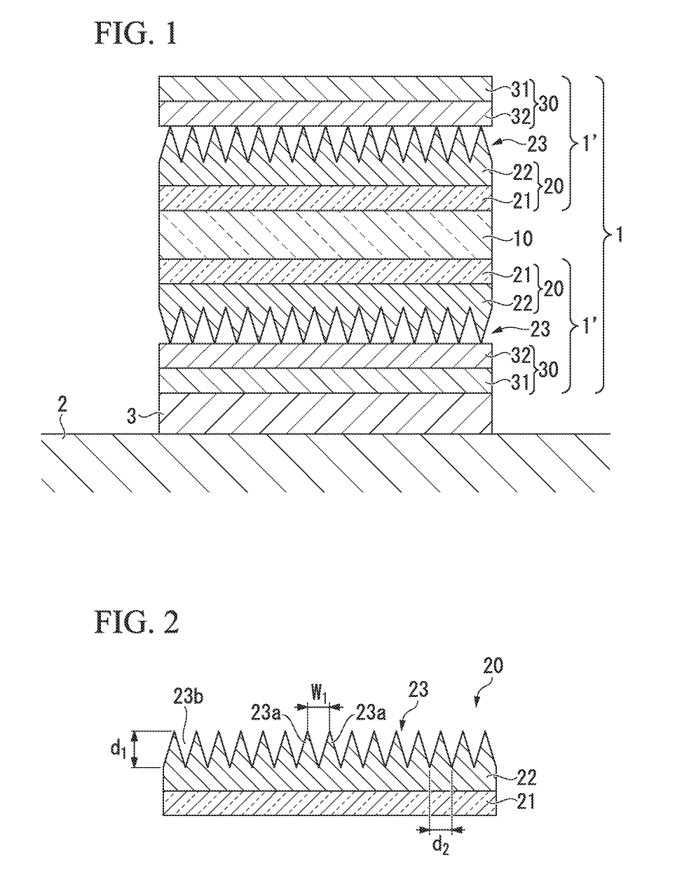

FIG. 1 is a vertically cross-sectional diagram showing an example of a molded body with double-side protection films (laminated structure) 1 used in the manufacturing method of a processed product of the present invention. The molded body with double-side protection films 1 of this example is formed by laminating molded bodies with a single-side protection film (laminated structure) 1′ on both surfaces of a first base material 10. In addition, in the molded bodies with a single-side protection film 1′, protection films 30 are attached to a surface of molded bodies 20, respectively.

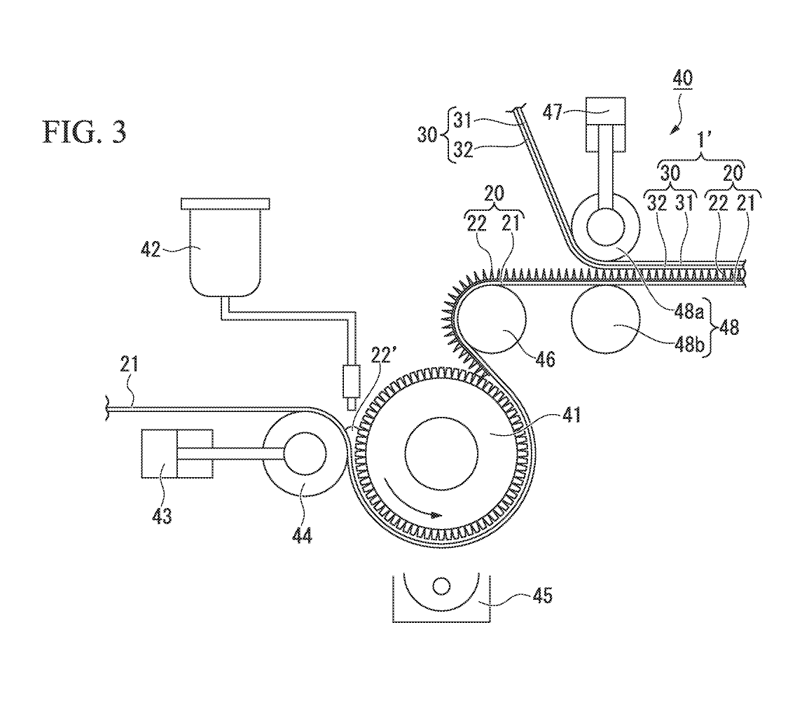

It should be noted that, in FIGS. 2 and 3, the same reference numerals are given to the same constituent elements as those of FIG. 1, and description thereof will not be repeated in some cases. In addition, in FIGS. 1 to 4, scales differ from members in order to set the sizes thereof to the extent that the members can be recognizable in the drawings.

In addition, in the present specification, “(meth)acrylate” means acrylate or methacrylate, and an “active energy ray” means a visible light ray, a UV ray, an electron ray, plasma, a heat ray (infrared ray, or the like), or the like.

In addition, a “molded body” in the present specification means an article formed with a fine concavo-convex structure, and a “laminated structure” means a structure obtained by attaching a protection film onto a surface of a molded body.

[Molded Body with Double-Side Protection Films (Laminated Structure)]

### <First Base Material>

A material used as a first base material 10 is not particularly limited as long as light transmits therethrough. For example, polycarbonate, a polystyrene-based resin, polyester, polyethersulfone, polysulfone, polyether ketone, polyurethane, an acrylic resin, glass, and the like can be exemplified.

The first base material 10 may be formed using any method of injection molding, extrusion molding, and cast molding.

The form of the first base material 10 is not particularly limited, but can be appropriately selected according to the form of the molded body 20, to be described later, and when, for example, the molded body 20 is an anti-reflection film, the form thereof is preferably a sheet or a film.

### <Molded Body>

Each molded body 20 shown in FIG. 1 includes a second base material 21 and a cured product 22 of an active energy ray curable resin composition formed on one face (surface) of the second base material 21.

As a material used in the second base material 21 is not particularly limited as long as light transmits therethrough. For example, a methyl methacrylate (co)polymer, polycarbonate, a styrene (co)polymer, a methyl methacrylate-styrene copolymer, cellulose diacetate, cellulose triacetate, cellulose acetate butyrate, polyester, polyamide, polyimide, polyether sulfone, polysulfone, polypropylene, polymethylpentene, polyvinyl chloride, polyvinyl acetal, polyether ketone, polyurethane, glass, and the like can be exemplified.

The second base material 21 may be formed using any method of injection molding, extrusion molding, and cast molding.

The form of the second base material 21 is not particularly limited, but can be appropriately selected according to the form of the manufactured molded body 20, and when the molded body 20 is an anti-reflection film, or the like, the form thereof is preferably a sheet or a film.

The second base material 21 may be provided with an adhesive layer and a separate film (both of which are not shown in the drawing) on the face (back face) thereof on which the cured product 22 is not formed. The second base material is easily attached to the first base material 10 by providing the adhesive layer.

In addition, in order to improve adhesiveness, an anti-static property, an abrasion resistance property, a weather resistance property, and the like of the second base material with the active energy ray curable resin composition, the surface of the second base material 21 may be subject to, for example, various coatings, or a corona discharge treatment.

The molded body 20 has a fine concavo-convex structure on its surface. The molded body 20 may be formed with the fine concavo-convex structure on its entire surface, or formed with the fine concavo-convex structure on a part of the surface. It should be noted that the portion formed with the fine concavo-convex structure is called an uneven portion 23.

The fine concavo-convex structure of the uneven portion 23 has a plurality of convexes including the cured product 22 of the active energy ray curable resin composition, to be described later, and thus, the portion is formed by transferring the fine concavo-convex structure of a surface of anodized alumina thereto.

As the fine concavo-convex structure, a so-called moth-eye structure in which a plurality of projections (convexes) substantially in conical shapes, pyramid shape, or the like are arranged is preferable. By providing the uneven portion 23 having the fine concavo-convex structure on the surface, the molded body 20 having an excellent anti-fouling property is obtained. Particularly, the moth-eye structure in which the intervals between convexes are equal to or shorter than the wavelength of visible light serves as effective anti-reflection means as refractive indexes continuously increase from a refractive index in the air to a refractive index of a material.

The average interval between the convexes is preferably 400 nm or shorter, more preferably 350 nm or shorter, and particularly preferably 250 nm or shorter. If the average interval between the convexes is the wavelength of visible light or shorter, that is, 400 nm or shorter, a molded body having low reflectance of visible light is obtained. Particularly, if the average interval of the convexes is the wavelength of visible light or shorter, that is, 400 nm or shorter, a molded body 20 having low reflectance and low dependency of reflectance on wavelengths is obtained.

The average interval between the convexes is preferably 25 nm or longer, and more preferably 80 nm or longer in light of easy formation of the convexes.

The average interval between the convexes is obtained by measuring 10 intervals of adjacent convexes (the distance W₁ from the center of a convex 23a to the center of an adjacent convex 23a in FIG. 2) in observation using an electronic microscope, and averaging the measured values.

In other words, the average interval between the convexes is preferably 25 to 400 nm, and more preferably 80 to 250 nm.

A height of the convexes is preferably 100 to 400 nm, and more preferably 150 to 300 nm.

If the height of the convexes is 100 nm or higher, reflectance becomes sufficiently low, and dependency of reflectance on a wavelength decreases. If the height of the convexes is 400 nm or lower, an abrasion resistance property of the convexes becomes favorable.

The height of the convexes is obtained by measuring 10 heights of convexes (the vertical distance d₁ from the tip of a convex 23a to the bottom of a concave 23b adjacent to the convex 23a in FIG. 2) in observation using an electronic microscope, and then averaging the measured values.

An aspect ratio of the convexes (a height of a convex/a length of the bottom face of the convex) is preferably 1 to 5, more preferably 1.2 to 4, and particularly preferably 1.5 to 3. If the aspect ratio of the convexes is 1 or higher, reflectance becomes sufficiently low. If the aspect ratio of the convexes is 5 or lower, the abrasion resistance property of the convexes becomes favorable.

If should be noted that the “length of the bottom face of a convex” is a length d₂ of the bottom of a convex 23a in the cross-section obtained when the convex 23a is cut from the tip thereof in the height direction in FIG. 2.

The shape of the convexes is preferably a shape in which the sectional areas of a convex in a direction orthogonal to the height direction continuously increase in a depth direction from the outermost surface, in other words, the sectional shape of a convex in the height direction is preferably a triangle, a trapezoid, a bell, or the like.

The molded body 20 includes the uneven portion 23 having the fine concavo-convex structure on its surface, and thus is appropriate for a molded body for optical applications, and particularly for an anti-reflection product such as a anti-reflection film, a stereoscopic anti-reflection body, or the like.

When the molded body 20 is an anti-reflection film, the body is used to be attached to surfaces of image display devices, for example, liquid crystal display devices, plasma display panels, electro-luminescence displays, and cathode tube display devices, and target objects including lenses, show windows, windows of gauges, lighting members, lenses of glasses, half-wavelength plates, low-pass filters, and the like.

When the molded body 20 is an anti-reflection body in a stereoscopic shape, the anti-reflection body can be manufactured in advance using a transparent base material of a shape appropriate for the application, and the body can be used as a member constituting a surface of a target object described above.

In addition, when the target object is an image display device, an anti-reflection film may be attached not only to a surface of the device but also to the front face plate thereof, and the front face plate can thereby be configured to be a molded body (laminated structure) of the present invention.

In addition to the above, as applications of the molded body 20, optical application molded bodies such as optical waveguides, relief holograms, polarization splitters, crystal devices, and the like, cell culture sheets, ultra-water-shedding films, ultra-hydrophilic films, and the like can be exemplified.

### <Protection Film>

The protection film 30 protects the surface of the molded body 20, and is attached to the surface of the molded body 20 as shown in FIG. 1, that is, the uneven portion 23 having the fine concavo-convex structure. Accordingly, the surface of the molded body 20 is difficult to be scratched even when it is allowed to come into contact with other objects. Furthermore, impurities such as dust are difficult to invade the interface of the molded body 20 and the protection film 30, and contaminants, and the like are difficult to adhere to the surface of the molded body 20.

In the protection film, an adhesive layer 32 including an adhesive is laminated on a base film material 31 as shown in FIG. 1, for example.

A material used in the base film material 31 is not particularly limited, but for example, a crystalline ethylene-based resin, crystalline propylene-based resins such as a crystalline propylene homopolymer, a random copolymer of propylene, α-olefin, and/or ethylene, or a block copolymer of propylene, α-olefin, and/or ethylene, an olefin-based resin such as poly(1-buten), poly(4-methyl-1-pentene), an acrylic resin such as polymethyle acrylate, polymethyl methacrylate, ethylene-ethyl acrylate copolymer, a styrene-based resin such as a butadiene-styrene copolymer, an acrylonitrile-styrene copolymer, a polystyrene resin, a styrene-butadiene-styrene block copolymer, a styrene-isoprene-styrene block copolymer, or a styrene-acrylic acid copolymer, a vinyl fluoride-based resin such as a vinyl chloride resin, a polyvinyl fluoride, or Vinylidene fluoride, a polyamide-based resin such as nylon 6, nylon 66, or nylon 12, a saturated ester-based resin such as polyethylene terephthalate, or polybutylene terephthalate, polycarbonate, polyphenylene oxide, polyacetal, polyphenylene sulfide, a silicone resin, a thermoplastic urethane resin, polyether ether ketone, polyetherimide, various thermoplastic elastomers, crosslinked products thereof, or the like can be exemplified.

A thickness of the base film material 31 can be appropriately selected within the scope in which adhesiveness, or the like is not impaired, and generally 3 to 500 μm, and preferably 5 to 200 μm. If the thickness of the base film material 31 is less than 3 μm, crinkles, or the like are easily generated in a manufacturing process of the protection film 30, and accordingly there are cases in which the film is hardly attached to the molded body 20. On the other hand, if the thickness of the base film material 31 exceeds 500 μm, handling of the protection film 30 is difficult in many cases.

The base film material 31 may undergo, for example, anti-fouling treatment, acid treatment, alkali treatment, primer treatment, anchor coat treatment, corona treatment, plasma treatment, UV ray treatment, or anti-static treatment if necessary.

An adhesive to form the adhesive layer 32 is not particularly limited, but for example, an ethylene-vinyl acetate copolymer (EVA), linear low density polyethylene (LLDPE), an ethylene-α-olefin copolymer, a styrene-butadiene-styrene block copolymer, a styrene-isoprene-styrene block copolymer, a styrene-ethylene-butylene-styrene block copolymer, a styrene-butadiene random copolymer, a water-added styrene-butadiene random copolymer, an acrylic polymer, or the like can be exemplified.

Such adhesives may be used singly or in combination of two or more kinds thereof.

In addition, a common additive such as a cross-linker, a cross-linking catalyst, a tackifier, a filler, a pigment, a colorant, an antioxidant, or the like may be blended with the adhesive, if necessary.

A thickness of the adhesive layer 32 can be appropriately selected within the scope in which adhesiveness, or the like is not impaired, and generally 1 to 100 μm, preferably 3 to 50 μm, and more preferably 5 to 30 μm.

For the purpose of antifouling, a peeling film (not shown) may be laminated on the surface of the adhesive layer 32 opposite to the surface on which the base film material 31 is laminated.

A resin used in the peeling film is not particularly limited, but for example, various resins, and the like previously exemplified in the description of the base film material 31 are exemplified. Among these, a polystyrene resin, a saturated ester-based resin, and a polyamide-based resin are preferable, and polyethylene terephthalate, and a polyamide-based resin are more preferable in terms of a peeling property.

In addition, in order to improve the peeling property of the peeling film, treatment of peeling silicone, or the like may be performed on the surface of the peeling film coming into contact with the adhesive layer 32 if necessary within the scope in which effect of the invention is not impaired.

A layer structure or the number of laminates of the protection film 30 is not particularly limited as long as the film includes at least one layer of the base film material 31 and at least one layer of the adhesive layer 32, but generally the number of layers is about 2 to 7.

As a specific example of a layer structure of the protection film 30, for example, base film material-adhesive layer, base film material-adhesive layer-detaching film, base film material-adhesive layer-base film material-adhesive layer, base film material-adhesive layer-base film material-adhesive layer-detaching film, and the like can be exemplified.

As a manufacturing method of the protection film 30, a co-extrusion molding method, a laminate molding method, and appropriate development mode such as a casting method, or a coating method are exemplified.

As the co-extrusion molding method, a method is exemplified in which the base film material 31 and the adhesive layer 32 are extruded in a molten state using a known method, for example, a T-die molding method or an inflation molding method, laminated with each other, and then cooled using cooling means such as a cooling roll.

As the laminate molding method, a method is exemplified in which the base film material 31 is prepared in advance using, for example, an extrusion molding method, the adhesive layer 32 is extruded in a molten state and laminated thereon, and then, they are cooled using cooling means such as a cooling roll.

As the casting or coating method, there is a method in which an adhesive solution of about 10 to 40 mass % is prepared by dissolving or dispersing a base polymer, or the like in a solvent including a single product or a mixed product of an appropriate solvent of, for example, toluene, ethyl acetate, or the like, and directly established on the base film material 31 using an appropriate development mode such as a casting mode or a coating mode, or in which the adhesive layer 32 is formed on the peeling film as described above, and transferred onto the base film material 31.

The protection film 30 used in the present invention has adhesion strength with respect to the fine concavo-convex structure of 0.1 to 1.7 N/25 mm. The strength is more preferably 0.1 to 0.2 N/25 mm. If the adhesion strength with respect to the fine concavo-convex structure is 0.1 N/25 mm or higher, the protection film 30 is neither raised from the molded body 20 nor detached in the middle of cutting process for forming the molded body 1 with double-side protection films in a desired shape, the position of the molded body 20 is seldom deviated during processing, or scratches are seldom made on the surface of the molded body 20. In addition, if the adhesion strength with respect to the fine concavo-convex structure is 1.7 N/25 mm or lower, residual adhesive seldom occurs in concaves of the fine concavo-convex structure of the molded body 20 when a cleaning process is performed after processing to be described below. In addition, operability when the protection film is detached from the molded body 20 is also satisfactory.

As the protection film that satisfies the above-described adhesive strength, commercialized protection films can be used.

For example, “E-MASK series” manufactured by Nitto Denko Corporation, “PAC series” of polyolefin-based films and “SAT series” of PET base masking manufactured by Sun A Kaken Co., Ltd., “EC series” manufactured by Sumiron Co., Ltd., “Mastak series” manufactured by Fujimori Kogyo Co., Ltd., “Hitalex series” manufactured by Hitachi Chemical Co., Ltd., “SAF series” manufactured by Futamura Chemical Co., Ltd., and the like are exemplified.

### [Manufacturing Method of a Processed Product]

A manufacturing process of a processed product of the present invention includes an attachment step in which a protection film that protects a surface of a molded body with a fine concavo-convex structure is attached on the surface, a processing step in which the protection film and the molded body are processed in a predetermined shape, and a cleaning step in which the protection film is detached from the processed laminated structure and then the molded body is washed.

Here, the predetermined shape means a desired shape or an arbitrary shape.

Hereinafter, an example of the manufacturing method of a processed product of the present invention will be described using the above-described molded body with double-side protection films 1.

### <Attachment Step>

In the attachment step, the protection film 30 that protects the surface of the molded body 20 with the fine concavo-convex structure is attached to the surface.

A method for attaching the protection film 30 on the molded body 20 is not particularly limited, but as will be described later, for example, a method in which the molded body 20 and the protection film 30 are supplied between a pair of nip rolls so that they are attached to each other, or the like, is exemplified. In addition, as will be described in more detail, steps of manufacturing and attachment of the molded body 20 may be continuously performed.

It should be noted that, when the molded body with double-side protection film 1 shown in FIG. 1 is to be created, it may be possible that the molded body 20 and the protection film 30 are attached to together using the above-described method, or the like so as to create two molded bodies with a single-side protection film 1′, and then they are attached to both faces of the first base material 10 in a laminating manner.

### <Processing Step>

In the processing step, the molded body with double-side protection film 1 prepared in the attachment step is processed in a predetermined shape.

A processing method is not particularly limited, but NC cutting is preferable. In NC cutting, a position and a path of a tool, rotation of a main axis, and a position of a workpiece can be programmed and thereby be controlled by controlling machine tools based on numerical information. Accordingly, processing can be performed with high accuracy and efficiency in production of diversified kinds in a small amount. In the processing, endmill processing in which an endmill is used in a tool of the NC cutting is used for cutting surfaces and contour, and can be easily used in step forming, bottom processing, hole processing, as well as groove processing.

When the molded body 20 in, for example, a sheet shape is processed using an NC cutter, the surface thereof is processed with the protection film 30 attached in general for the purpose of preventing scratches, cut scraps (cut power) or contaminants from adhering to the surface of the molded body 20.

According to the present invention, since processing is performed after the protection film 30 is attached to the surface of the molded body 20 in the attachment step, scratches or contaminants are rarely made on the surface of the molded body 20.

In addition, in the processing step, for the purpose of fixing the molded body with double-side protection films 1 to a work table 2 as shown in FIG. 1, a back-up sheet 3 may be interposed therebetween. Then, when the molded body with double-side protection films 1 is processed, the molded body is half-cut to the middle of the back-up sheet 3 without causing complete cutting of the back-up sheet 3. Accordingly, contact of a cutting tool with the work table 2 is avoided, and thereby wearing of the cutting edge of the tool and nicks of the table can be prevented.

For the back-up sheet 3, a protection film that includes a base material and an adhesive layer is generally used.

A thickness of the base material of the back-up sheet 3 is preferably 50 to 1000 μm. When the thickness of the base material is 50 μm or thicker, half-cut easily does not occur, and accordingly, not resulting in contact of the cutting tool with the work table 2 that is the cause of wearing of the cutting edge. When the thickness of the base material is equal to or thinner than 1000 μm, cost for the base material does not increase, and thereby a handling property is favorable.

Adhesion strength of the adhesive layer of the back-up sheet 3 to the base film material 31 of the protection film 30 is preferably 0.2 to 5 N/25 mm. When the adhesion strength is 0.2 N/25 mm or higher, the molded body with double-side protection films 1 is easily held during processing, and thereby, deviation in a position of the molded body with double-side protection film 1 does not easily occur.

However, when adhesiveness of the protection film 30 is weak as described above, the protection film 30 becomes loose or is detached in the middle of processing, and thereby the position of the molded body 20 is deviated. In addition, cut scraps (cut powder) invade between the molded body 20 and the protection film 30, causing inconvenience as scratches and contaminants. In order to resolve the problems, a method for simply increasing the adhesiveness of the protection film 30 is considered, but a component (adhesive) of the adhesive layer 32 is transferred to the fine concavo-convex structure of the molded body 20 and then becomes a cause of contamination, or generates a residual adhesive in concaves of the fine concavo-convex structure.

However, according to the present invention, the protection film 30 can be easily processed without being easily detached in the middle of processing when the protection film 30 having the above-described specific adhesion strength is used, and accordingly, a processed product with little residual adhesive can be manufactured.

It should be noted that, in the present invention, the protection film 30 constituting the molded body with double-side protection films 1 can also serve as the back-up sheet 3.

In addition, the molded body with double-side protection films 1 may be vacuum-attracted to the work table 2 via the back-up sheet 3 for the purpose of firmly fixing the molded body to the work table 2.

### <Cleaning Step>

In the cleaning step, the protection film 30 is detached from the molded body with double-side protection films 1 that has been processed in the processing step, and the molded bodies 20 laminated on both faces of the first base material 10 are washed.

As described above, the protection film 30 needs to have adhesiveness (adhesion strength) to the extent that the position of the molded body 20 is not deviated in the middle of processing. However, if the adhesion strength of the protection film 30 is strengthened, there are cases in which a residual adhesive remains in concaves of the fine concavo-convex structure of the molded body 20 when the protection film 30 is detached from the molded body with double-side protection films 1 after the processing step. The cleaning step is performed to remove the residual adhesive.

The method for cleaning the molded body 20 is not particularly limited, but dry cleaning in which an object to be washed is exposed in a gaseous ambient such as ozone, plasma, or the like or wet cleaning in which an object to be washed is exposed to a liquid such as an organic solvent, a cleaning solution, or the like is exemplified. Wet cleaning is preferable in terms of easiness in handling and no damage to the fine concavo-convex structure of the molded body 20 during cleaning.

As wet cleaning, wiping, ultrasonic cleaning, immersion cleaning, waterjet cleaning, and the like are preferable.

As cleaning solution used in wet cleaning, an organic solvent, or a water-based cleaning solution is preferable. As a specific example of cleaning solution, for example, a cleaning solution obtained by blending an organic solution such as water, ethanol, methanol, acetone, or the like with an acid, neutral, and alkaline surfactant can be exemplified. To be more specific, “Cemiclean series” manufactured by Yokohama Oils & Fats Industry Co., Ltd., “Toho-clean series” manufactured by Toho Chemical Industry Co., Ltd., “GC series” manufactured by BEX Inter-Corporation, and the like are exemplified.

The cleaning solutions may be used singly, or in combination of two or more kinds.

As conditions for wet cleaning, the temperature of a cleaning solution is preferably 10° C. to 70° C., and the cleaning time is preferably 1 to 60 minutes.

In addition, after cleaning is completed using a cleaning solution, components of the cleaning solution (such as a surfactant) attached to the surface of the molded body 20 is preferably rinsed and removed using water or an organic solvent.

### <Other Steps>

After passing the above-described cleaning step, a protection film is preferably attached to the processed product with the fine concavo-convex structure processed in a predetermined shape for the purpose of protecting the fine concavo-convex structure from scratches and contaminants during handling after the step.

As the protection film used in the processed product, a film that seldom causes a residual adhesive during detachment thereof is preferable, and adhesion strength of the protection film to an acrylic resin plate is preferably 0.1 N/25 mm or higher and less than 0.2 N/25 mm.

[Manufacturing of Molded Body with Double-Side Protection Films]

The above-described molded body with double-side protection films 1 can be manufactured in such a way that the molded body with single-side protection film 1′ that is manufactured using a manufacturing device 40 of a molded body with a single-side protection film shown in, for example. FIG. 3 is attached onto both faces of the first base material 10 in a laminating manner.

<Manufacturing Device of a Molded Body with Single-Side Protection Film>

FIG. 3 is a schematic configuration diagram showing an example of the manufacturing device 40 of a molded body with single-side protection film, and the manufacturing device 40 in this example includes a roll-shaped mold 41 having the surface with a fine concavo-convex structure, a tank 42 that contains an active energy ray-curable resin composition 22′, a nip roll 44 provided with a pneumatic cylinder 43, an active energy ray radiation device 45, a detaching roll 46, and a pair of nip rolls 48 provided with a pneumatic cylinder 47.

It should be noted that the manufacturing device 40 of a molded body with a single-side protection film shown in FIG. 3 is a device that manufactures the molded body with single-side protection film 1′ continuously after the molded body 20 is manufactured.

### (Roll-Shaped Mold)

The roll-shaped mold 41 is a mold for transferring the fine concavo-convex structure to the active energy ray-curable resin composition 22′, and has anodized alumina on its surface. The mold having the anodized alumina on its surface can be set to have a large area, and is convenient for creating a roll-shaped mold.

The anodized alumina is an aluminum porous oxide film (almite), and has a plurality of fine pores (concaves) on its surface.

The mold having the anodized alumina on its surface can be manufactured through, for example, the following steps (a) to (e).

(a) A step of forming an oxide film by causing anodization of a roll-shaped aluminum in an electrolytic solution under a constant voltage.

(b) A step of removing the oxide film and forming fine pore generation points of anodization.

(c) A step of repeating anodization of the roll-shaped aluminum in an electrolytic solution, and forming an oxide film having fine pores at the fine pore generation points.

(d) A step of enlarging the diameters of the fine pores.

(e) A step of repeating the step (c) and the step (d).

Step (a):

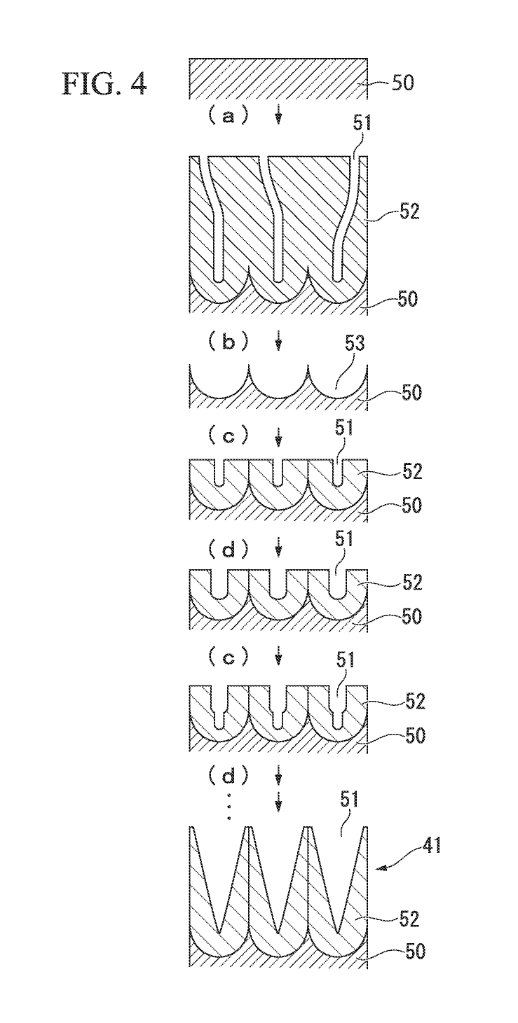

As shown in FIG. 4, when the aluminum 50 is anodized, the oxide film 52 having fine pores 51 is formed.

The purity of the aluminum is preferably 99% or higher, more preferably 99.5% or higher, and particularly preferably 99.8%. When the purity of the aluminum is low, an concavo-convex structure in a size that scatters visible light due to segregation of impurities is formed, or regularity of fine pores obtained in anodization is lowered during anodization.

As an electrolytic solution, sulfuric acid, oxalic acid, phosphoric acid, and the like are exemplified.

When oxalic acid is used as an electrolytic solution:

The concentration of oxalic acid is preferably 0.7 M or lower. If the concentration of the oxalic acid exceeds 0.7 M, a current value becomes excessively high, and thus, the surface of the oxide film becomes rough.

When a formation voltage is 30 to 60 V, anodized alumina having pores with high regularity of a cycle of 100 nm can be obtained. When a formation voltage is higher or lower than the range, the regularity tends to be low.

The temperature of the electrolytic solution is preferably 60° C. or lower, and more preferably 45° C. or lower. If the temperature of the electrolytic solution exceeds 60° C., the phenomenon of so-called “burn” occurs, and thus, the fine pores break or the surface melts, resulting in destroyed regularity of the fine pores.

When sulfuric acid is used as the electrolytic solution:

The concentration of the sulfuric acid is preferably 0.7 M or lower. If the concentration of the sulfuric acid exceeds 0.7 M, a current value becomes excessively high, and accordingly, a constant voltage cannot be maintained.

When a formation voltage is 25 to 30 V, anodized alumina having fine pores with high regularity of a cycle of 63 nm can be obtained. When a formation voltage is higher or lower than the range, the regularity tends to be low.

The temperature of the electrolytic solution is preferably 30° C. or lower, and more preferably 20° C. or lower. If the temperature of the electrolytic solution exceeds 30° C., the phenomenon of so-called “burn” occurs, and thus, the fine pores break or the surface melts, resulting in destroyed regularity of the fine pores.

Step (b):

As shown in FIG. 4, the oxide film 52 is first removed, it is set to be the fine pore generation points 53 of anodization, and accordingly regularity of the fine pores can improve.

Step (c):

As shown in FIG. 4, the aluminum 50 from which the oxide film is removed is anodic-oxidized again so as to form a oxide film 52 having cylindrical fine pores 51.

The anodization may be performed under the same conditions as those in Step

(a). As the time for the anodization is lengthened, deeper fine pores can be obtained.

Step (d):

As shown in FIG. 4, a process of enlarging the diameters of the fine pores 51 (hereinafter, described as a fine pore diameter enlargement process) is performed. The fine pore diameter enlargement process is a process in which the diameters of the fine pores obtained by immersing the oxide film in a solution to be dissolved and then anodic-oxidized are enlarged. As such a solution, for example, about 5 mass % of a phosphoric acid aqueous solution, or the like is exemplified.

As the time of the fine pore diameter enlargement process is lengthened, the diameters of the fine pores increase.

Step (e):

As shown in FIG. 4, when anodization of step (c) and the fine pore diameter enlargement process of step (d) are repeated, anodized alumina having fine pores 51 in a shape in which the diameter continuously decrease in the depth direction from the opening portion is formed, and the mold having the anodized alumina on its surface (roll-shaped mold 41) is obtained.

The number of repetition is preferably three times or more, and more preferably 5 times or more in total. If the number of repetition is two times or fewer, the diameters of the fine pores discontinuously decrease, and thus, a reflectance reduction effect of the cured product 22 manufactured using the anodized alumina having the fine pores is insufficient.

The surface of the anodized alumina may be processed with a mold release agent so as to make separation from the cured product 22 easy. As a processing method, for example, a method for coating the surface with a silicone resin or fluorine-containing polymer, a method for depositing a fluorine-containing compound thereon, a method for coating the surface with a fluorine-containing silane coupling agent or a fluorine-containing silicone-based silane coupling agent, and the like are exemplified.

As the shape of the fine pore 51, a substantial conical shape, a pyramid shape, a cylinder shape, and the like are exemplified, and a shape such as a conical shape, a pyramid shape, and the like, in which a cross-sectional area of a fine pore in a direction orthogonal to the depth direction continuously decreases in the depth direction from the outermost surface is preferable.

The average interval between the fine pores 51 is preferably 400 nm or shorter, and more preferably 350 nm or shorter. Particularly, if the average interval of the fine pores 51 is 400 nm or shorter, the molded body 20 having lower reflectance and low dependency of reflectance on a wavelength is obtained.

The depth of the fine pores 51 is preferably 100 to 400 nm, and more preferably 150 to 300 nm.

The aspect ratio (the height of a fine pore/the length of the opening part of the fine pore) of the fine pores 51 is preferably 1 to 5, more preferably 1.2 to 4, and particularly preferably 1.5 to 3.

It should be noted that the length of the opening part of a fine pore is the length of the opening of a cut plane when the fine pore is cut in the depth direction from the deepest part of the fine pore.

### (Tank)

The tank 42 contains the active energy ray-curable resin composition 22′, and supplies the active energy ray-curable resin composition 22′ between the roll-shaped mold 41 and the strip-like second base material 21 that moves along the surface of the roll-shaped mold 41.

### (Nip Roll)

The nip roll 44 is dispose facing the roll-shaped mold 41. The nip roll 44 nips the second base material 21 and the active energy ray-curable resin composition 22′ with the roll-shaped mold 41.

Nipping pressure is adjusted using the pneumatic cylinder 43 provided with the nip roll 44.

### (Active Energy Ray Radiation Device)

The active energy ray radiation device 45 is disposed below the roll-shaped mold 41, radiates active energy rays so that the active energy ray-curable resin composition 22′ filled between the second base material 21 and the roll-shaped mold 41 is cured. As the active energy ray-curable resin composition 22′ is cured, the cured product 22 to which the fine concavo-convex structure of the roll-shaped mold 41 is transferred is formed on the second base material 21.

As the active energy ray radiation device 45, a high-pressure mercury lamp, a metal halide lamp, and the like can be used. The amount of light radiation energy in this case is preferably 100 to 10000 mJ/cm².

### (Peeling Roll)

The peeling roll 46 is disposed on the downstream side of the active energy ray radiation device 45, and peels the second base material 21 having a surface on which the cured product 22 is formed from the roll-shaped mold 41.

### (The Pair of Nip Rolls)

The pair of nip rolls 48 is disposed on the downstream side of the peeling roll 46, and causes the protection film 30 to attach to the molded body 20.

The pair of nip rolls 48 includes an elastic roll 48a of which the outer circumferential face is formed of an elastic member such as rubber, and a rigid roll 48b of which the outer circumferential face is formed of a member having high rigidity such as metal.

Nipping pressure is adjusted by the pneumatic cylinder 47 provided with the elastic roll 48a.

### (Active Energy Ray-Curable Resin Composition)

The active energy ray-curable resin composition 22′ appropriately contains monomer, oligomer, and responsive polymer having a radial polymeric coupling and/or cation polymeric coupling in molecules, and may contain a non-responsive polymer.

A monomer having the radical polymeric coupling is not particularly limited.

For example, (meth)acrylate derivatives such as methyl (meth)acrylate, ethyl (meth)acrylate, propyl (meth)acrylate, n-butyl (meth)acrylate, i-butyl (meth)acrylate, s-butyl (meth)acrylate, t-butyl (meth)acrylate. 2-ethylhexyl (meth)acrylate, lauryl (meth)acrylate, alkyl (meth)acrylate, tridecyl (meth)acrylate, stearyl (meth)acrylate, cyclohexyl (meth)acrylate, benzyl (meth)acrylate, phenoxyethyl (meth)acrylate, isobornyl (meth)acrylate, glycidyl (meth)acrylate, tetrahydrofurfuryl (meth)acrylate, allyl (meth)acrylate, 2-hydroxyethyl (meth)acrylate, hydroxypropyl (meth)acrylate, 2-methoxyethyl (meth)acrylate, and 2-ethoxyethyl (meth)acrylate, styrene derivatives such as (meth)acrylic acid, (meth) acrylonitril, styrene, and α-methyl styrene, monofunctional monomers of (meth)acrylamide derivatives such as (meth)acrylamide, N-dimethyl (meth)acrylamide, N-diethyl (meth)acrylamide, and dimethylaminopropyle (meth) acrylamide, bifunctional monomers such as ethylene glycol di(meth)acrylate, tripropylene glycol di(meth)acrylate, isocyanuric ethylene oxide modified di(meth)acrylate, triethyleneglycol di(meth)acrylate, diethyleneglycol di(meth)acrylate, neopentyl glycol di(meth)acrylate, 1,6-hexanediol di(meth)acrylate, 1,5-pentanediol di(meth)acrylate, 1,3-butylene glycol di(meth)acrylate, polybutylene glycol di(meth)acrylate, 2,2-bis(4-(meth) acryloxy polyethoxyphenyl)propane, 2,2-bis(4-(meth) acryloxy ethoxyphenyl)propane, 2,2-bis(4-(3-(meth) acryloxy-2-hydroxypropoxy)phenyl)propane, 1,2-bis(3-(meth) acryloxy-2-hydroxypropoxy)ethane, 1,4-bis(3-(meth) acryloxy-2-hydroxypropoxy)butane, dimethylol tricyclodecane di(meth)acrylate, ethylene oxide adduct di(meth)acrylate of bisphenol A, propylene oxide adduct di(meth)acrylate of bisphenol A, hydroxypivalic acid-based neopentyl glycol di(meth)acrylate, divinylbenzene, and methylene bisacrylamide, trifunctional monomers such as pentaerythritol tri(meth)acrylate, trimethylol propan tri(meth)acrylate, trimethylol propane ethylene oxide modified tri(meth)acrylate, trimethylol propane propylene oxide modified triacrylate, trimethylol propane ethylene oxide modified triacrylate, and isocyanuric ethylene oxide modified tri(meth)acrylate, multifunctional monomers such as a condensed reactive mixture of succinic acid/trimethylolethane/acrylic acid, dipentaerythrithol hexa(meth)acrylate, dipentaerythrithol penta(meth)acrylate, ditrimethylol propane tetraacrylate, and tetramethylolmethane tetra(meth)acrylate, bi- or higher functional urethane acrylate, bi- or higher functional polyester acrylate, and the like are exemplified. The elements may be used singly or in combination of two or more kinds thereof.

A monomer with the cation polymeric coupling is not particularly limited, but monomers having an epoxy group, an oxetanyl group, an oxazolyl group, a vinyl oxy group, and the like are exemplified, and among these, the monomer having the epoxy group is particularly preferable.

As examples of oligomer and reactive polymers, an unsaturated polyesters such as a condensate of unsaturated dicarboxylic acid and polyvalent alcohol, polyester (meth)acrylate, polyeter (meth)acrylate, polyol (meth)acrylate, epoxy (meth)acrylate, urethane (meth)acrylate, a cation polymeric epoxy compound, and a single polymer or a copolymer of the described monomers with the radical polymeric coupling in the side chain.

Monomers, oligomers, and responsive polymers with the cation polymeric coupling according to the present invention are not particularly limited as long as they are compounds with cation polymeric functional groups (cation polymeric compound), and any of monomers, oligomers, and prepolymers may be possible.

A number of kinds of cation polymeric functional groups are known, but among these, a cyclic ether group such as an epoxy group, and an oxetanyl group; a vinyl ether group; a carbonate group (O—CO—O group), and the like can be exemplified as functional groups with high practicality.

As representative cation polymeric compounds, a cyclic ether compound such as an epoxy compound, an oxethane compound, and the like; a vinyl ether compound; a carbonate-based compound such as a cyclic carbonate compound, or a dithiocarbonate compound, and the like are exemplified.

As non-responsive polymers, an acrylic resin, a styrene-based resin, a polyurethane resin, a cellulose resin, a polyvinyl butylal resin, a polyester resin, thermoplastic elastomer, and the like are exemplified.

An active energy ray-curable composition generally contains a polymerization initiator for curing. A polymerization initiator is not particularly limited, but a known initiator can be used.

When optical reaction is used, a radial polymerization initiator, or a cation polymerization initiator are exemplified as an optical polymerization initiator.

A radical polymerization initiator can be used without particular limitation as long as it generates acid from radiation of known active energy rays, and specifically, an acetophenone-based optical polymerization initiator, a benzoin-based optical polymerization initiator, a benzophenone-based optical polymerization initiator, a thioxanthone-based optical polymerization initiator, an acyl phosphine oxide-based optical polymerization initiator, and the like are exemplified.

As the acetophenone-based optical polymerization initiator, acetophenone, p-(tert-butyl)-1′,1′,1′-trichloroacetophenone, chloroacetophenone, 2′,2′-diethoxyacetophenone, hydroxyacetophenone, 2,2-dimethoxy-2′-phenylacetophenone, 2-aminoacetophenone, dialkylaminoacetophenone, and the like are exemplified.

As the benzoin-based optical polymerization initiator, benzyl, benzoin, benzoin methyl ether, benzoin ethyl ether, benzoin isopropyl ether, benzoin isobutyl ether, 1-hydroxycyclohexyl phenyl ketone, 2-hydroxy-2-methyl-1-phenyl-2-methylpropane-1-on, 1-(4-isopropylphenyl)-2-hydroxy-2-methylpropane-1-on, benzyl dimethyl ketal, and the like are exemplified.

As the benzophenone-based optical polymerization initiator, benzophenone, benzoylbenzoic acid, benzoyl methyl benzoate, methyl o-benzoylbenzoate, 4-phenylbenzophenone, hydroxybenzophenone, hydroxypropylbenzophenone, acryl benzophenone, 4,4′-bis(dimethylamino)benzophenone, and the like are exemplified.

As the thioxanthone-based optical polymerization initiator, thioxanthone, 2-chloro thioxanthone, 2-methyl thioxanthone, diethyl thioxanthone, dimethyl thioxanthone, and the like are exemplified.

As the acyl phosphine oxide-based optical polymerization initiator, 2,4,6-trimethyl benzoyldiphenyl phosphine oxide, benzoyldiethoxy phosphine oxide, bis 2,4,6-trimethyl benzoylphenyl phosphine oxide, and the like are exemplified.

In addition, as other radical polymeric initiator, α-acyloxime ester, benzyl-(o-ethoxycarbonyl)-α-monooxime, glyoxyester, 3-ketocoumarin, 2-ethyl anthraquinone, camphorquinone, tetramethyl thiuram sulfide, azobisisobutyronitrile, benzoyl peroxide, dialkyl peroxide, tert-butyl peroxypivalate, and the like are exemplified.

The radical polymeric initiators may be used singly or in combination of two or more kinds.

A cation polymeric initiator can be used without particular limitation as long as it generates acid from radiation of known active energy rays, and for example, a sulfonium salt, an iodonium salt, a phosphonium salt, and the like are exemplified.

As a sulfonium salt, for example, triphenyl sulfonium hexafluorophosphate, triphenyl sulfonium hexafluoroantimonate, bis(4-(diphenylsulfonio)-phenyl)sulfide-bis(hexafluorophosphate), bis(4-(diphenylsulfonio)-phenyl)sulfide-bis(hexafluoroantimonate), 4-di(p-toluen) sulfonio-4′-tert-butyl phenylcarbonyl-diphenyldisulfide hexafluoroantimonate, 7-di(p-toluen)sulfonio-2-isopropyl thioxanthone hexafluorophosphate, 7-di(p-toluen)sulfonio-2-isopropyl thioxanthone hexafluoroantimonate, and the like can be exemplified.

As an iodonium salt, for example, diphenyl iodonium hexafluorophosphate, diphenyl iodonium hexafluoroantimonate, bis(dodecylphenyl)iodonium tetrakis(pentafluorophenyl)borate, and the like are exemplified.

As a phosphonium salt, for example, tetrafluoro phosphonium hexafluorophosphate, tetrafluoro phosphonium hexafluoroantimonate, and the like can be exemplified.

When thermal reaction is used, as specific examples of thermal polymeric initiators, for example, organic peroxides such as methyl ethyl ketone peroxide, benzoyl peroxide, dicumyl peroxide, t-butyl hydroperoxide, cumene hydroperoxide, t-butyl peroxyoctoate, t-butyl peroxybenzoate, lauroyl peroxide, and the like; azo-based compound such as azobisisobutyronitrile, and the like; redox polymeric initiators obtained by combining amines such as N,N-dimethylaniline, N,N-dimethyl-p-toluidine, and the like with the organic peroxide, and the like are exemplified.

The added amount of a polymeric initiator is 0.1 to 10 parts by mass with respect to 100 parts by mass of an active energy ray-curable composition. If the amount is 0.1 parts by mass or more, polymerization easily proceeds, and if the amount if 10 parts by mass or less, an obtained cured product is not colored, or mechanical strength thereof is not lowered.

In addition, in addition to the above-described elements, an anti-static agent, a mold release agent, an additive such as a fluorine compound for improving an anti-fouling property, fine particles, a trifle amount of solvent, and the like may be added to the active energy ray-curable composition.

<Manufacturing of the Molded Body with Single-Side Protection Film>

An example of a method for manufacturing the molded body with single-side protection film 1′ using the above-described manufacturing device 40 of a molded body with single-side protection film will be described.

### (Production of a Molded Body)

First, the molded body 20 is produced.

To be specific, as shown in FIG. 3, the strip-like second base material 21 is transported along the surface of the rotating roll-shaped mold 41, and the active energy ray-curable resin composition 22′ is supplied from the tank 42 to the space between the second base material 21 and the roll-shaped mold 41.

Furthermore, the second base material 21 and the active energy ray-curable resin composition 22′ are nipped between the roll-shaped mold 41 and the nip roll 44 of which nipping pressure is adjusted by the pneumatic cylinder 43, the active energy ray-curable resin composition 22′ is uniformly spread between the second base material 21 and the roll-shaped mold 41, and at the same time, filled into the concaves of the fine concavo-convex structure of the roll-shaped mold 41.

Then, active energy rays emitted from the active energy ray radiation device 45 installed below the roll-shaped mold 41 is radiated on the active energy ray-curable resin composition 22′ through the second base material 21, then the active energy ray-curable resin composition 22′ is cured, and thereby the cured product 22 onto which the fine concavo-convex structure on the surface of the roll-shaped mold 41 is transferred is formed.

Then, the second base material 21 having the surface on which the cured product 22 is formed is peeled by the peeling roll 46, and thereby the molded body 20 is obtained.

The surface of the cured product 22 formed by transferring the fine pores 51 as shown in FIG. 4 has a so-called moth-eye structure.

### (Attachment of a Protection Film)

Next, the protection film 30 is attached onto the surface of the obtained molded body 20.

To be specific, the molded body 20 obtained in advance is made to pass between the pair of nip rolls 48, and at the same time, the protection film 30 delivered from a protection film delivery device (not shown in the drawn) is supplied between the molded body 20 and the pair of nip rolls 48 so as to be attached onto the surface of the molded body on which the fine concavo-convex structure is formed.

At this moment with regard to the molded body 20, the molded body 20 is sent between the elastic roll 48a and the rigid roll 48b so that the back face of the molded body 20 (face on which the fine concavo-convex structure is not formed) comes into contact with the rigid roll 48b.

Meanwhile, the protection film 30 is sent between the elastic roll 48a and the molded body 20 so that the adhesive layer 32 comes into contact with the surface of the molded body 20 (face on which the fine concavo-convex structure is formed), and the base film material 31 comes into contact with the elastic roll 48a.

Then, in the state in which the adhesive layer 32 of the protection film 30 comes into contact with the surface of the molded body 20, the molded body 20 and the protection film 30 are pinched between the elastic roll 48a and the rigid roll 48b, and then the protection film 30 is attached to the molded body 20 while nipping pressure of the pair of nip rolls 48 is adjusted by the pneumatic cylinder 47. In this manner, the molded body with a single-side protection film 1′ in which the protection film 30 is attached onto the surface of the molded body 20, that is, the uneven portion 23 as shown in FIG. 1 is obtained.

It should be noted that, since the surface of the molded body 20 comes into contact with the elastic roll 48a via the protection film 30, the fine concavo-convex structure thereof is difficult to be deformed, or damaged.

As the protection film 30 any film that is separately produced in the above-described method may be used as long as it has specific adhesion strength, and a commercialized film may be used.

Manufacturing the molded body with a single-side protection film 1′ in such a way that the molded body 20 is produced as described above, and then the protection film 30 is subsequently attached thereto is preferable when the purpose of attaching the protection film 30 (prevention of adhesion of contaminants, and maintenance of the shape of the fine concavo-convex structure) and manufacturing cost are considered, but it is not limited thereto, and after the molded body is produced, the molded body may be taken up first, and then transferred to another manufacturing line so as to be attached with the protection film 30.

### [Actions]

As described above, according to the manufacturing method of a processed product according to the present invention, a processed product that can be easily processed without casual separation of the protection film 30 during processing and has little residual adhesive can be manufactured by using the protection film having specific adhesion strength and performing a cleaning step after a processing step.

In addition, according to the present invention, since the fine concavo-convex structure of the molded body can be protected during the processing step, a processed product in a complicated shape without scratches and adhesion of contaminants can be easily manufactured.

Thus, the present invention is proper for processing of a molded body that has conspicuous deviation of a position thereof particularly during processing and has a fine concavo-convex structure on both faces.

### Other Embodiments

The manufacturing method of a processed product according to the present invention is not limited to the above-described method. In the above-described method, the molded body with double-side protection film 1 shown in FIG. 1 is processed, but a target to be processed is not limited to the molded body with double-side protection film 1 shown in the drawing. For example, the molded body with a single-side protection film 1′ as shown in FIG. 1 may be processed.

### EXAMPLES

Hereinafter, the present invention will be described in detail using examples, but the present invention is not limited thereto.

### (2) Measurement of Adhesion Strength of the Protection Film to the Fine Concavo-Convex Structure (Object to be Attached)

The protection film was attached to the surface on which the fine concavo-convex structure is formed under the condition of 0.3 Mpa using a laminating machine. With regard to measurement of adhesion strength, adhesion strength of the protection film to the fine concavo-convex structure was measured in such a way that a molded body with the protection film (laminated structure) was set in a tensilon tester (manufactured by Orientec, “Tensilon RTC-1210”), 180° peeling test was performed on the spot of the surface formed with the fine concavo-convex structure and attached with the protection film based on JIS Z-0237 using a load cell of 10 N.

### Example 1

### Production of a Roll-Shaped Mold

Forging processing was performed on an aluminum ingot having purity of 99.90%, a fabric polishing was performed on a cylindrical aluminum prototype that had been cut so as to have a diameter of 200 mm, an inner diameter of 155 mm, and a thickness of 350 mm without a roll mark, and then electrolytic polishing was performed thereon using a mixed solution of perchloric acid and ethanol (volume ratio of 1:4) so as to make it have a specular surface.

Then, anodization was performed on the aluminum prototype having the specular surface in an aqueous oxalic acid solution of 0.3 M at a bath temperature of 16° C. under the condition of 40V DC for 30 minutes, and thereby an oxide film having a thickness of 3 μm was formed (step (a)). After the formed oxide film was first melted in a mixed solution of 6 mass % of phosphoric acid and 1.8 mass % of chromic acid, and then removed (step (b)), anodization was performed again for 30 seconds under the same conditions as in the step (a), and thereby an oxide film was formed (step (c)). Then, the film was immersed in 5 mass % of an aqueous phosphoric acid solution (30° C.) for 8 minutes, and a pore diameter enlargement process for enlarging the diameters of fine pores of the oxide film was performed (step (d)).

Further, the steps (c) and (d) were repeated so as to be executed five times in total (step (e)), and thereby a roll-shaped mold having a surface on which anodized alumina having tapered fine pores in a substantial conical shape with opening portions of the fine pores having a length of 100 nm and a depth of 230 nm was obtained.

Then, the roll-shaped mold was dipped in a solution of 0.1 mass % of “OPTOOL DSX (trade name)” that is a mold release agent manufactured by Daikin Industries Ltd. for 10 minutes, dried by wind for 24 hours, and then a fluorination process was performed on the surface of the oxide film.

<Manufacture of the Molded Body with a Single-Side Protection Film>

The obtained roll-shaped mold was set in the manufacturing device 40 for a molded body with a single-side protection film shown in FIG. 3, then the molded body 20 was produced, and the molded body with a single-side protection film 1′ was subsequently manufactured.

First, as shown in FIG. 3, the roll-shaped mold 41 was fitted into an axial core made of carbon steel for a mechanical structure provided with a flow path for cooling water therein. Then, the active energy ray-curable resin composition 22′ having the following composition was supplied onto the second base material 21 (“Acryplen” which is an acrylic film manufactured by Mitsubishi Rayon Co., Ltd. having a film width of 340 mm and a length of 400 m) nipped between the nip roll 44 and the roll-shaped mold 41 from the tank 42 via a supply nozzle at room temperature.

At this moment, the active energy ray-curable resin composition 22′ is nipped by the nip roll 44 of which nipping pressure is adjusted by the pneumatic cylinder 43, and also fills inside the concaves of the roll-shaped mold 41.

Then, while the rolled-shaped mold 41 is rotated at a speed of 7.0 m per minute, UV rays of 240 W/cm emitted from the UV ray radiation device 45 are radiated on the active energy ray-curable resin composition 22′ in the state of being pinched between the roll-shaped mold 41 and the second base material 21, then the active energy ray-curable resin composition 22′ is cured and shaped so as to become the cured product 22, then is peeled from the roll-shaped mold 41 by the peeling roll 46, and then the molded body (transparent sheet) 20 having the uneven portion 23 with a fine concavo-convex structure on its surface as shown in FIG. 2 was obtained.

As a result of observing the surface of this molded body 20 using an SEM, convexes having opening portions of fine pores with a length of 100 nm and a height of 230 nm were formed in the uneven portion 23, and accordingly, a fine concavo-convex structure to which the fine concavo-convex structure of the roll-shaped mold is favorably transferred was formed.

Then, the molded body 20 was sent between the elastic roll 48a and the rigid roll 48b so that the back face (face on which the fine concavo-convex structure was not formed) of the molded body 20 came into contact with the rigid roll 48b.

Meanwhile, the protection film 30 was sent between the elastic roll 48a and the molded body 20 so that the adhesive face (adhesive layer) of the protection film (“HR-6010” manufactured by Nitto Denko Corporation) 30 was allowed to come into contact with the surface (face on which the fine concavo-convex structure is formed) of the molded body 20.

Then, while nipping pressure of the pair of nip rolls 48 were adjusted by the pneumatic cylinder 47 (to be 0.1 MPa to 0.5 MPa), the protection film 30 was attached onto the surface of the molded body 20, and thereby the molded body with a single-side protection film 1′ as shown in FIG. 1 was obtained.

It should be noted that adhesion strength of the protection film 30 to the fine concavo-convex structure was 0.36 N/25 mm.

### (Active Energy Ray-Curable Resin Composition)

Trimethylolethane acrylate•anhydride succinic condensed ester: 75 parts by mass

“Aronix M206” manufactured by Toagosei Co., Ltd.: 20 parts by mass

Methyl acrylate: 5 parts by mass

“Irgacure 184” manufactured by Ciba Specialty Chemicals Inc.: 1.0 parts by mass

“Irgacure 819” manufactured by Ciba Specialty Chemicals Inc.: 0.1 parts by mass

### <Evaluation>

### (Evaluation of a Cut Processing Property)

The obtained molded body with a single-face protection film 1′ was laminated on both faces of the first base material 10 (“Acrylite L” manufactured by Mitsubishi Rayon Co., Ltd. having a thickness of 0.15 cm, and length and width of 20×30 cm) using a laminating machine, and thereby the molded body with double-side protection films 1 formed with the fine concavo-convex structure on both faces was obtained.

Furthermore, after the back-up film 3 was laminated on a single face of the molded body with double-side protection films 1 as shown in FIG. 1, and the side of the back-up film 3 was vacuum-attracted so as to be fixed to the work table 2 of an NC processing machine.

Then, using an endmill, the molded body with double-side protection films 1 was cut so as to have a length and width of 5 cm, thereby cutting out a single test piece having a size of 5×5 cm (processing step), and then the piece was evaluated based on following evaluation criteria. The results are shown in Table 1.

◯: Substantially favorable cut processing could be performed without detachment of the protection film, and chipping (burr) did not occur on a cut face.

x: The protection film was detached during the cut processing. Otherwise, chipping (burr) occurred on a cut face.

### (Measurement of Haze of a Processed Product)

Haze of a processed product was measured using a hazemeter (manufactured by Suga Test Instruments Co., Ltd.) based on JIS K7361-1.

### (Reflectance of the Processed Product)

Relative reflectance of the surface of a cured resin film was measured using a spectrophotometer (U-4000 manufactured by Hitachi Ltd.) at an incidence angle of 5° and a wavelength in the range of 380 to 780 nm, and then reflectance of visible light was computed based on JIS R3 106.

### (Evaluation of a Residual Adhesive)

Through the above-described processing step, the protection film 30 was detached from the test piece that had been cut out from the molded body with double-side protection films 1, the molded bodies 20 laminated on both faces of the first base material 10 was ultrasonic-cleaned using an alkaline cleaning solution (cleaning step), and thereby a processed product was obtained. The presence or absence of foreign substances on the obtained processed product was observed in the eyes using a microscope to determine a residual adhesive based on the following evaluation criteria. The results are shown in Table 1.

©: No residual adhesive was found even without alkaline cleaning

◯: A residual adhesive could be removed through alkaline cleaning

x: A residual adhesive could not be removed even through alkaline cleaning

No residual adhesive: A change of reflectance is less than 0.05, a change of haze is less than 0.2, and no impurities were found in observation of eyes and microscope.

### Example 2

A molded body with a protection film was manufactured and processed and then evaluated in the same manner as in Example 1 except that a protection film (“RB-200S” manufactured by Nitto Denko Corporation) having adhesion strength with respect to the fine concavo-convex structure of 0.38 N/25 mm was used. The results are shown in Table 1.

### Example 3

A molded body with a protection film was manufactured and processed and then evaluated in the same manner as in Example 1 except that a protection film (“EC-625” manufactured by Sumiron Co., Ltd.) having adhesion strength with respect to the fine concavo-convex structure of 0.83 N/25 mm was used. The results are shown in Table 1.

### Example 4

A molded body with a protection film was manufactured and processed and then evaluated in the same manner as in Example 1 except that a protection film (“R-200” manufactured by Nitto Denko Corporation) having adhesion strength with respect to the fine concavo-convex structure of 0.95 N/25 mm was used. The results are shown in Table 1.

### Example 5

A molded body with a protection film was manufactured and processed and then evaluated in the same manner as in Example 1 except that a protection film (“SAT HC1138T10-J” manufactured by Sun A Kaken Co., Ltd.) having adhesion strength with respect to the fine concavo-convex structure of 0.19 N/25 mm was used. The results are shown in Table 1.

### Example 6

A molded body with a protection film was manufactured and processed and then evaluated in the same manner as in Example 1 except that a protection film (“FM-125” manufactured by Daio Kakousi Industry Limited) having adhesion strength with respect to the fine concavo-convex structure of 0.12 N/25 mm was used. The results are shown in Table 1.

### Comparative example 1

A molded body with a protection film was manufactured and processed and then evaluated in the same manner as in Example 1 except that a protection film (“P-3020” manufactured by Hitachi Chemical Co., Ltd.) having adhesion strength with respect to the fine concavo-convex structure of 3.80 N/25 mm was used. The results are shown in Table 1.

### Comparative example 2

A molded body with a protection film was manufactured and processed and then evaluated in the same manner as in Example 1 except that a protection film (“P-3030” manufactured by Hitachi Chemical Co., Ltd.) having adhesion strength with respect to the fine concavo-convex structure of 3.15 N/25 mm was used. The results are shown in Table 1.

### Comparative example 3

A molded body with a protection film was manufactured and processed and then evaluated in the same manner as in Example 1 except that a protection film (“P-3040” manufactured by Hitachi Chemical Co., Ltd.) having adhesion strength with respect to the fine concavo-convex structure of 1.80 N/25 mm was used. The results are shown in Table 1.

### Comparative example 4

A molded body with a protection film was manufactured and processed and then evaluated in the same manner as in Example 1 except that a protection film (“SAF-300M” manufactured by Futamura Chemical Co. Ltd.) having adhesion strength with respect to the fine concavo-convex structure of 1.80 N/25 mm was used. The results are shown in Table 1.

### Comparative example 5

A molded body with a protection film was manufactured and processed and then evaluated in the same manner as in Example 1 except that a protection film (“RB-100S” manufactured by Nitto Denko Corporation) having adhesion strength with respect to the fine concavo-convex structure of 0.05 N/25 mm was used. The results are shown in Table 1.

TABLE 1

| | Adhesion | | | | |
|---|---|---|---|---|---|
| | strength | | | | |
| | with respect | | | | |
| | to fine | | | | |
| | concavo- | | | | |
| | convex | Cut | Evaluation | | |
| | structure | processing | of residual | Reflectance | Haze |
| | [N/25 mm] | property | adhesive | [%] | [%] |
| Example 1 | 0.36 | ◯ | ◯ | 0.14 | 0.8 |
| Example 2 | 0.38 | ◯ | ◯ | 0.15 | 0.8 |
| Example 3 | 0.83 | ◯ | ◯ | 0.14 | 0.8 |
| Example 4 | 0.95 | ◯ | ◯ | 0.14 | 0.8 |
| Example 5 | 0.19 | ◯ | © | 0.16 | 0.8 |
| Example 6 | 0.12 | ◯ | © | 0.16 | 0.8 |
| Comparative | 3.80 | ◯ | X | 0.15 | 1.3 |
| example 1 | | | | | |
| Comparative | 3.15 | ◯ | X | 0.17 | 2.0 |
| example 2 | | | | | |
| Comparative | 1.80 | ◯ | X | 0.16 | 1.0 |
| example 3 | | | | | |
| Comparative | 1.80 | ◯ | X | 0.21 | 0.9 |
| example 4 | | | | | |
| Comparative | 0.05 | X | — | — | — |
| example 5 | | | | | |

| | | |
|---|---|---|
| Initial stage (without protection film) | 0.16 | 0.8 |

As understood from Table 1, in the cases of Examples 1 to 6 in which protection films having adhesion strength with respect to the fine concavo-convex structure of 0.1 to 1.7 N/25 mm were used, NC cutting using an endmill was possible without the problem of detachment of the protection films from the molded bodies during the processing. In addition, no residual adhesive was found in the processed products after cleaning. It should be noted that, in Examples 5 and 6, no residual adhesive was found even before alkaline cleaning was performed.

On the other hand, in the cases of Comparative examples 1 to 4 in which protection films having adhesion strength to acryl resin plates of over 1.7 N/25 mm were used, NC cutting was possible, but the adhesion strength of the protection films was excessively strong, so a residual adhesive was found in processed products after cleaning.

In the case of Comparative example 5 in which a protection film having adhesion strength with respect to the acryl resin plate of less than 0.1 N/25 mm was used, since the adhesion strength of the protection film was excessively weak, so the protection film was detached from the molded body during the NC cutting, and it was not possible to perform the NC cutting on the molded body in a desired shape while performance of the molded body was maintained. Thus, a residual adhesive was not evaluated.

### INDUSTRIAL APPLICABILITY

According to the laminated structure of the present invention, the laminated structure for manufacturing a processed product that can be easily processed without causing easy detachment of a protection film and has little residual adhesive can be provided.

According to the manufacturing method of a processed product of the present invention, a processed product, which can be easily processed without causing a protection film to be easily detached and has little residual adhesive when a molded body with a fine concavo-convex structure on its surface onto which the protection film is attached is processed, can be manufactured.

### REFERENCE SIGNS LIST

1 molded body with double-side protection films (laminated structure)
1′ molded body with a single-side protection film (laminated structure)
10 first base material
20 molded body
21 second base material
22 cured product
23 uneven portion
23a convex
23b concave
30 protection film
31 base film material
32 adhesive layer

1. A laminated structure comprising:
a molded body with a fine concavo-convex structure on a surface thereof; and
a protection film that is allowed to come into contact with the surface of the molded body on the side of the fine concavo-convex structure,
wherein the average interval between convexes of the fine concavo-convex structure is equal to or shorter than a wavelength of visible light, and
wherein adhesion strength of the protection film when the film is attached to the fine concavo-convex structure is 0.1 to 1.7 N/25 mm.

2. A manufacturing method of a processed product for processing the laminated structure according to claim 1 to be a processed product in a predetermined shape, the method comprising:
an attachment step of attaching a protection film onto a surface having a fine concavo-convex structure of the molded body to protect the surface; and
a processing step of processing the protection film and the molded body to be in a predetermined shape.

3. The manufacturing method of a processed product according to claim 2, further comprising:
a cleaning step of detaching the protection film from the laminated structure after the processing step according to claim 2, and then cleaning the molded body.

4. The manufacturing method of a processed product according to claim 3, wherein the cleaning step is a wet cleaning step using a cleaning solution.
